(19) United States
(12) Patent Application Publication
(10) Pub. No.: US 2024/0175995 A1
(43) Pub. Date: May 30, 2024

(54) LASER RADAR RANGING METHOD AND DETECTION SYSTEM

(71) Applicants: Qi LIU, Chaoyang District (CN); Ningbo ABAX Sensing Electronic Technology Co., Ltd., Ningbo City, Zhejiang Province (CN)

(72) Inventors: Shuyu LEI, Ningbo City, Zhejiang Province (CN); Yishuo SONG, Beijing (CN)

(73) Assignees: Qi LIU, Chaoyang District, BE (CN); Ningbo ABAX Sensing Electronic Technology Co., Ltd., Ningbo City, Zhejiang Province (CN)

(21) Appl. No.: 18/552,773

(22) PCT Filed: Mar. 7, 2022
(86) PCT No.: PCT/CN2022/079511

§ 371 Date: Sep. 27, 2023

(30) Foreign Application Priority Data
Mar. 29, 2021 (CN) 202110334626.6
Sep. 23, 2021 (CN) 202111112299.6
Feb. 14, 2022 (CN) 202210132268.5

(51) Int. Cl. G01S 7/4863; G01S 7/4865; G01S 17/26

(52) U.S. Cl. CPC G01S 7/4863; G01S 7/4865; G01S 17/26

(57) ABSTRACT

A LIDAR ranging method and a detection system. The detection system includes: a drive signal generating unit configured to generate a driving signal and act on a laser source through a laser modulation driving circuit, wherein the laser source receives the driving signal to emit a pulsed laser sequence; an array-type returned light receiving module configured to receive the returned light signal reflected by a detected object in the field of view and generate a returned signal; and a processing module configured to generate a modulation signal according to the driving signal generated by the driving signal generator, obtain a distance-related signal based on the modulation signal according to a preset rule, and outputs the distance information of the detected object according to the distance-related signal.

### CROSS REFERENCE TO RELATED APPLICATIONS

The present application claims priorities to Chinese Patent Application No. 202110334626.6, titled “LIDAR RANGING METHOD AND DETECTION SYSTEM”, filed on Mar. 30, 2021 with the Chinese Patent Office, and Chinese Patent Application No. 202111112299.6, titled “LIDAR DETECTION SYSTEM”, filed on Sep. 23, 2021 with the Chinese Patent Office, and Chinese Patent Application No. 202210132268.5, titled “LIDAR DETECTION SYSTEM AND DETECTION METHOD”, filed on Feb. 14, 2022 with the Chinese Patent Office, all of which are incorporated herein by reference in their entireties.

### FIELD

The present disclosure relates to the technical field of detection technology, and in particular, to LIDAR ranging method and detection system.

### BACKGROUND

A distance detection system, especially the active detection system realized by a laser source, the principle of the detection system is that, the light source actively emitted emitting light for detection, such as near-infrared detection light with wavelength which can be selected in the range of 800-1200 nm, here is not limited. The near-infrared detection waves can also ensure safety when there is a human object in the field of view. Therefore, active detection systems with near-infrared detection wave are more and more widely used in various scenarios, such as autonomous driving, smart doors locks, security cameras, mobile phone 3D cameras, etc.

Time of Flight (TOF) light detection and Ranging (LIDAR) is a technique for long-range distance detection. TOF LIDAR sensors determine the distance between an instrument including the sensor and an object by detecting the time that a laser pulsed takes to travel between the instrument and the object.

Currently widely used detection methods include Indirect Time of Flight (ITOF) measurement scheme and Direct Time of Flight (DTOF) measurement scheme. Most of the indirect time-of-flight measurement schemes use the method of measuring phase offset, that is, measuring the phase difference between the emitted wave and the received wave. The abscissa of the emitted wave and the received wave is the time, and the ordinate of the emitted wave and the received wave is the light intensity. According to the phase difference between the emitted wave and the received wave, the flight time t can be obtained, and the distance of the detected object can be calculated according to the formula D=ct/2. The direct flight time measurement scheme generally uses a measurement system with picosecond resolution (mostly SPAD+TDC) to directly obtain the time difference triggered by the transmitter and the corresponding receiver, which is the flight time t, so as to calculate the distance of the detected object. In addition, there is also a type of detection method, which is called coherent detection, the specific principle of the coherent detection is as follows: the coherent laser signal and the local laser oscillation signal satisfy the wavefront matching condition (that is, the coherent laser signal and the local laser oscillation signal on the photosensitive surface of the entire laser detector maintain the same phase relationship), they are incident on the photosensitive surface of the detector together, resulting in beat frequency or coherent superposition. The output electrical signal of the detector is proportional to the square of the sum of the laser signal wave to be measured and the local laser oscillation wave. The above detection methods, of course, have their own advantages, but they still have great deficiencies in terms of pixel-level, fast processing and efficient use of emitted energy.

In recent years, some LIDAR principles for direct time-of-flight detection (incoherent) have also been developed, gradually becoming a detection technology that is more widely understood. The Chinese patent application number CN202010604232.3 titled “a new type of laser ranging method and LIDAR system, and a new type of detection mechanism” proposed a new type of detection mechanism. The principle of coherent light is not used on the optical path in the new type of detection mechanism, but the correlation operation is performed in the electrical signal stage, and further through the correlation operation of the electrical signal obtains the final distance or other information of the detected object. However, the above methods have the following limitations: (1) According to the principle of incoherent chirped signal AM continuous wave laser 3D imaging, the difference frequency signal is generated by multiplying the delayed chirp signal and the local oscillator signal. From the perspective of energy utilization, due to the A/D conversion of the difference frequency signal, the energy of the difference frequency signal within the sampling interval of the A/D conversion is not used, and the energy of the delayed chirp signal is proportional to the energy emitted by the continuous wave laser. Therefore, the average laser emission power of the existing technology (incoherent chirped signal amplitude-modulated continuous wave laser 3D imaging) is relatively high, and the ranging range is relatively small; (2) Devices of broadband amplifiers, mixers and A/D converters etc. are used, the dynamic range of these devices limits the dynamic range of the received laser signal, thus limiting the dynamic receiving range; (3) The performance of the formed laser 3D imaging system is more affected by the chirp signal FM linearity and FM flatness.

Therefore, in order to overcome the above mentioned technical problems, it is urgent to develop a more efficient detection method and detection system, which can maximize the use of the returned energy of the emitted laser in terms of energy efficiency, In the aspect of anti-interference, it can adapt to more detection systems in the field of view to effectively identify the objects detected and obtain accurate range information.

### SUMMARY

In view of the above, the present disclosure provides a detection method and a detection system for obtaining distance information, so as to accurately and stably output stable and accurate distance results of the detected objects within each distance range in the field of view.

In order to achieve the above object, solutions in the embodiments of the present disclosure are provided.

In a first aspect, a LIDAR ranging method is provided according to an embodiment of the present disclosure, the LIDAR ranging method includes:

A driving signal is generated by a driving signal generating unit and acts on the laser source through the laser modulation driving circuit, and the laser source receives the driving signal to emit a pulsed laser sequence;

Receiving the returned light signal reflected by the detected object in the field of view and generating the returned signal by the array type returned light receiving module; and

A modulation signal is generated by a processing module according to the driving signal generated by the driving signal generating unit, the processing module follows a preset rule and according to the modulation signal to obtain a distance-related signal, and the processing module outputs the distance information of the detected object bases on the distance-related signal.

In a second aspect, a detection system for distance detection is provided according to an embodiment of the present disclosure, the detection system includes: a driving signal generating unit, the driving signal generating unit is configured to generate a driving signal, and the driving signal acts on a laser source through a laser modulation driving circuit, the laser source receives the driving signal and drives to emit a pulsed laser sequence; an array type returned light receiving module is configured to receive the returned light signal reflected by the detected object in the field of view, and generates the returned signal; and a processing module, the processing module is configured to generate a modulation signal according to the driving signal generated by the driving signal generating unit, processing module follows a preset rule and according to the modulation signal to obtain a distance-related signal, and the processing module outputs the distance information of the detected object according to the distance-related signal.

The beneficial effect of the discourse is:

A LIDAR ranging method and a detection system are provided according to embodiments of the present disclosure. The LIDAR ranging method includes: A driving signal is generated by a driving signal generating unit and the driving signal acts on a laser source through a laser modulation driving circuit, and the laser source receives the driving signal to emit a pulsed laser sequence; Receiving the returned light signal reflected by the detected object in the field of view and generating the returned signal by the array type returned light receiving module; and a modulation signal is generated by a processing module according to the driving signal generated by the driving signal generating unit, the processing module follows a preset rule and according to the modulation signal to obtain a distance-related signal, and the processing module outputs the distance information of the detected object according to the distance-related signal. The driving signal to drive the light source to emit a pulsed laser sequence is provided in the disclosure, on the one hand, the emitted energy can be greatly reduced, and on the other hand, the accuracy of the detection result can be guaranteed by the distance correlation signal which is obtained by calculating the signal generated by the returned light according to the preset rules. Further, preset operations between the modulation sequence and more than one photon triggering statistical results of single-photon avalanche diode arrays or similar APD array detectors in the disclosure which can reduce the actual number of operations, make the complexity of the entire statistics and operations is greatly reduced and ensures the high efficiency of the entire detection system and the ranging method. In addition, a counting sequence generation module generates an adaptive counting sequence according to the returned signal, and the processing module obtains the distance-related signal based on the adaptive counting sequence and the modulation signal to finally obtain the distance information of the detected object, in this way, which can enhance the anti-jamming capability of the radar detection system. Further, a counting sequence splicing module obtains a replica splicing signal according to the returned signal, and a processing module obtains the distance-related signal based on the replica splicing signal and the modulation signal to finally obtain the distance information of the detected object, in this way, a smaller ranging deviation can be achieved by a smaller laser emitting energy.

### BRIEF DESCRIPTION OF THE DRAWINGS

In order to illustrate technical solutions of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagram showing a modularized working principle of a detection system according to an embodiment of the present disclosure;

FIG. 2 is a schematic diagram showing a detection scheme according to an embodiment of the prior art;

FIG. 3 is a schematic diagram showing implementing of a pulsed detection scheme according to an embodiment of the present disclosure;

FIG. 4 is a schematic diagram showing an array-type receiving module according to an embodiment of the present disclosure;

FIG. 5 is a schematic diagram showing an operation module of preset rule according to an embodiment of the present disclosure;

FIG. 6 is a schematic diagram showing a counting sequence statistics result of returned light of a laser sequence that emits L times according to an embodiment of the present disclosure;

FIG. 7 is a schematic diagram showing utilizing the drive signal to generate discrete modulation sequence according to an embodiment of the present disclosure;

FIG. 8 is a schematic diagram showing obtaining a distance-related signal by using a preset rule operation module according to an embodiment of the present disclosure;

FIG. 9 is a schematic diagram showing another obtaining a distance-related signal by using a preset rule operation module according to an embodiment of the present disclosure;

FIG. 10 is a schematic diagram showing obtaining a distance-related signal according to an embodiment of the present disclosure;

FIG. 11 is a schematic diagram showing a three-dimensional imaging system according to an embodiment of the present disclosure;

FIG. 12 is a flowchart of generating an adaptive counting sequence according to an embodiment of the present disclosure;

FIG. 13 is a flowchart of generating an adaptive cumulative count sequence according to an embodiment of the present disclosure;

FIG. 14 is another flow chart showing generating an adaptive counting sequence according to an embodiment of the present disclosure;

FIG. 15 is a flowchart showing generating an adaptive cumulative count sequence according to a pre-generated adaptive correction sequence according to an embodiment of the present disclosure;

FIG. 16a to FIG. 16c are schematic diagrams showing the spectrum of the distance-related signal without the adaptive counting sequence or the adaptive cumulative counting sequence according to the embodiment of the present disclosure;

FIG. 17 is a schematic diagram showing the spectrum of the distance-related signal with the adaptive counting sequence or the adaptive cumulative counting sequence according to the embodiment of the present disclosure;

FIG. 18 is a schematic diagram showing a detection system according to the embodiment of the present disclosure;

FIG. 19 is another schematic diagram showing detection system according to the embodiment of the present disclosure;

FIG. 20 is a schematic diagram showing a replica splicing sequence according to the embodiment of the present disclosure;

FIG. 21 is another schematic diagram showing a replica splicing sequence according to the embodiment of the present disclosure;

FIG. 22 is a schematic diagram showing waveforms during three-dimensional imaging according to the embodiment of the present disclosure.

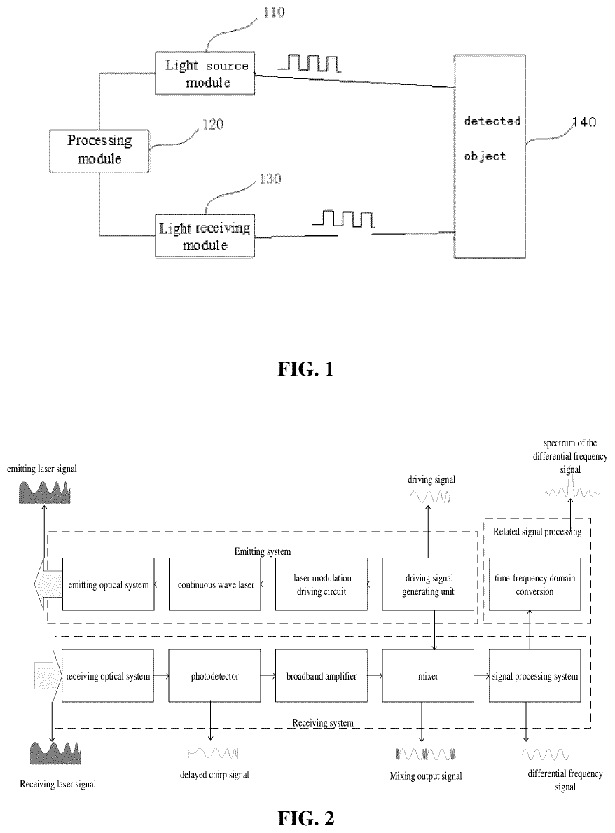

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those skilled in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

The detection system currently used basically includes: the light source module 110, a processing module 120, and a light receiving module 130. The light source module 110 includes, but is not limited to, a semiconductor laser, solid-state lasers, and other types of lasers. When a semiconductor laser is used as the light source, a vertical cavity surface emitting laser VCSEL (Vertical-cavity surface-emitting laser) or an edge-emitting semiconductor laser EEL (edge-emitting laser) can be used, which is only exemplary and not limited herein. The waveform of the light outputted by the light source 110 may be a square wave, a triangular wave, a sine wave, or the like, which is generally implemented as a laser with a certain wavelength in the distance measurement application, such as an infrared laser of 950 nm and other infrared lasers (optimally near-infrared lasers). The emitted light is projected into a view field, and a detected object 140 in the view field may reflect the projected laser light to form a return light. The return light enters the detection system and is received by the light receiving module 130. The light receiving module 130 may include a photoelectric conversion section, such as an array sensor formed by CMOS or CCD. The light receiving module may further include multiple lenses to form one or more image planes, that is, the light receiving module contains one or more image planes. The photoelectric conversion section of the light receiving module is located at one of the image planes, which may receive delay receiving signals of 0°, 90°, 180° and 270° with the most common four-phase solution. The four-phase distance calculation solution is illustrated herein by taking the sine wave as an example. The amplitude of the received signal is measured at four equally spaced points (for example, 90° or at a (¼) λ interval). The distance calculation formula of the four-phase distance measurement is shown as follows.

$$φ = ArcTan ( \frac{{A}_{1} - {A}_{3}}{{A}_{2} - {A}_{4}} ) \qquad ( 1 )$$

A ratio of a difference between A₁ and A₃ to a difference between A₂ and A₄ is equal to the tangent of the phase angle. ArcTan is actually a bivariate inverse tangent function that can be mapped to the appropriate quadrant, and defined as 0° or 180° in the case of A₂=A₄ and A₁>A₃ or A₃>A₁, respectively.
The distance to the object is determined by the following formula:

$$d = \frac{c \cdot φ}{4 π \cdot f} \qquad ( 2 )$$

Further, the frequency of the emitted laser is required to be determined to perform the distance measurement, where c represents the light speed, φ represents a phase angle (measured in radians), and f represents a modulation frequency. The above scheme can achieve the effect of distance detection for the detected object in the field of view, and this scheme is called the four-phase delay scheme to obtain the detection result. Of course, the photoelectric conversion of the receiving module generates different information. In some cases, the 0° and 180° two-phase scheme is used to obtain the information of the detected object. In addition, the acquisition of the target information by the 0°, 120° and 240° three-phase solution is disclosed in some documents, and a five-phase delay solution is disclosed in even some documents, which is not specifically limited in the present disclosure. In actual measurement, a square wave is also used for detection. The mechanism is similar to that of a sine wave, but the calculation formula is different and will not be described in detail here.

In the DTOF ranging, since the pixel unit of the array sensor is a SPAD (Single Photon Avalanche Diode, single-photon avalanche photodiode) device, it is an avalanche photodiode operating in a Geiger mode. In Geiger mode, the absorption of photons by avalanche photodiodes will generate electron-hole pairs, the electron-hole pairs are accelerated by the strong electric field generated by the high reverse bias voltage to obtain sufficient energy, and then collide with the lattice, creating a chain reaction, resulting in a large number of electron-hole pairs, causing an avalanche phenomenon, and the current increases exponentially. At this time, the gain of the SPAD is theoretically infinite, and a single photon can saturate the photocurrent of the SPAD. Therefore, the SPAD becomes the first choice for high-performance single-photon detection systems. The principle of ranging is described in detail below. The light source emits a pulsed laser with a certain pulse width, for example, several nanoseconds, and the pulsed laser is reflected by the detection target and returns to the array-type receiving module containing the SPAD in the avalanche state. The detection unit in the avalanche state can receive the returned signal, and after processing by the processing module, the distance between the detection system and the detection target can be output to complete the detection. In order to obtain high-confidence results, tens of thousands of laser pulses can be emitted, and the detection unit obtains a statistical result, so that a more accurate distance can be obtained by processing the statistical results. Two typical ranging methods, the ITOF ranging method and the DTOF ranging method are compared by the applicant of the present application, as shown in Table 1 below. From the comparison in Table 1, it can be seen that these two time-of-flight ranging schemes have certain limitations, and a new detection method needs to be developed to obtain more accurate and anti-jamming results.

TABLE 1
Comparison of ITOF and DTOF ranging methods

| Point of | Methods | |
|---|---|---|
| comparison | ITOF | DTOF |
| Receiving mode | 4 times correlated reception | Multiple direct reception, form |
| | and 1 time background light | a range-amplitude spectrum |
| | reception | (time domain) |
| Signal detection | Time-domain | Time-domain |
| | over-threshold detection | over-threshold detection |
| Distance solution method | Time-domain accumulation | Wave rise edge, time of |
| | values inverse | flight |
| | trigonometric functions | |
| The main congenital | 1. Modulation frequency: | 1. Adaptive setting of |
| problem of distance | the contradiction between | amplitude threshold in time |
| solution | fuzzy distance and | domain |
| | precision | 2. Accurate determination |
| | 2. Poisson distribution: | of rising edge time |
| | the contradiction between | |
| | cumulative energy and | |
| | precision | |
| | 3. Time domain solution: | |
| | background light affects | |
| | time domain accumulation | |
| | and precision | |
| Difficult of implement the | Analog/digital architecture: | digital architecture: |
| receiver/processor because | 1. modulation consistency | 1. Extremely short |
| of the distance solution | and response consistency in | accumulative intervals and |
| method | multiple correlation | accurate reference clocks to |
| | reception | ensure accuracy |
| | 2. modulation consistency | 2. Multi-digit storage to |
| | and response consistency | achieve waveform |
| | between the pixels of the | reproduction |
| | array | 3. Enormous pressure on |
| | 3. Large potential well | the transmission of |
| | depth for high dynamic | information |
| | range reception | |
| | 4. High Bit A/DC | |

FIG. 2 shows a non-coherent (direct detection solution) method for obtaining information such as the distance of a detected object in the prior art. As shown in FIG. 2, the driving signal generating unit generates a driving signal, and the driving signal here can be a driving signal with an identification function. For example, the period of the signal gradually increases or decreases gradually. Of course, a driving signal with certain characteristics and identification functions can also be obtained through some specific functions or internal algorithms, a chirp signal is used as an example here, but the actual implementation is not limited to this. The driving signal acts on the laser emitter through a laser modulation driving circuit, the laser emitter is a continuous wave laser emitter here, thereby emitting a detection laser with a law similar to that of the driving signal. A returned laser signal is formed by the detection laser is reflected by the detected object in the field of view. Due to the difference in distance between the detected objects in the field of view, different areas of the light receiving module can obtain delayed return light signals. A delayed start signal is obtained by the light receiving module through photoelectric conversion, the delayed start signal passes the bandwidth amplifier, then the correlation processing is performed between the delayed start signal and the drive signal, inside the mixer to obtain a mixed output signal. The signal processor processes the mixed output signal to obtain a differential frequency signal, wherein the signal processor may include a low-pass filter circuit to filter out clutter interference to obtain a real useful differential frequency signal. The amplifier can amplify the differential frequency signal after filtering, and then obtain a to-be-processed differential frequency signal with strong anti-interference ability and more real signal, and finally converted by an A/D converter to obtain a digital signal. The converted digital type differential frequency signal is passed to a time-frequency domain conversion module, which can obtain the frequency spectrum of the differential frequency signal through time-frequency domain conversion, and finally, through the features of the spectrum, such as peak value, the final detection result related to the features of the spectrum, such as the velocity and distance of the detected object, is identified. In addition, in order to ensure that the converted signal in frequency domain achieves the detection requirements, the time-frequency conversion module can also include a threshold detection unit and an information calculation unit etc. As shown in FIG. 2 the driving signal generator is used as a chirp signal generator for further illustration. The chirp signal generator generates two chirp signals, one is used as the local oscillator signal of the mixer, and the other is sent to the laser modulation drive circuit, so that the laser power emitted by the continuous wave laser varies as follows:

Pₜ(t)=Pₜ₀[1+mₜ cos(2πf₀t+πkt²+θ₀)],t∈[0,T] (3)

In the formula, Pₜ₀ is the average laser emission power; mₜ is the emitting modulation depth; f₀ is the starting frequency of the chirp signal; t is the time; k is the frequency modulation slope and k=B/T (B is the chirp signal bandwidth, T is the chirp signal period), θ₀ is the initial phase.

The receiving optical system focuses the laser signal reflected by the detected object to the photodetector, and obtains the delayed chirp signal through photoelectric conversion. The signal is amplified and mixed with the local oscillator signal, and the differential frequency signal is obtained after low-pass filtering. where the delayed chirp signal is:

Aᵣ(t)=Aᵣ₀[1+mₜ cos(2πF₀(t−τ)+πk(t−τ)²+θ₀+ϕ₀)],t∈[τ,T+τ] (4)

In the formula, Aᵣ₀ is the average amplitude of the delayed chirp signal; ϕ₀ is the additional phase introduced by the detected object reflection; τ=2R/c (R is the relative distance of the target, c is the speed of light in vacuum) is the time of flight between the detected object and a rangefinder.

The local oscillator signal is:

A_{LO}(t)=A_{LO0}[1+m_{LO} cos(2πf₀t+πkt²+θ_{LO})],t∈[0,T] (5)

In the formula, A_{LO0} is the average amplitude of the local oscillator signal, m_{LO} is the modulation depth of the local oscillator signal, θ_{LO} is the initial phase of the local oscillator signal.

The differential e frequency signal is:

s_{IF}(t)=A_{IF} cos(2πkτt+2πf₀τ−πkτ²+φ₀),t∈[τ,T] (6)

In the formula, A_{IF} is the amplitude of the differential frequency signal, and φ₀ is the phase of the differential frequency signal.

After amplifying the differential frequency signal, perform A/D conversion, and obtain its frequency spectrum through fast Fourier transform (FFT), and perform threshold detection on the frequency spectrum to obtain the frequency of the differential frequency signal:

$$R = \frac{cT}{2 B} {f}_{𝔽} \qquad ( 7 )$$

According to the relationship between the frequency of the differential frequency signal and the relative distance of the detected object, the relative distance of the detected object is obtained as:

$$R = \frac{cT}{2 B} {f}_{𝔽} \qquad ( 8 )$$

Although the above incoherent type of detection technology can supplement some defects of ITOF and DTOF and even coherent detection methods to a certain extent, the above-mentioned prior art still has the following limitations in detection:

(1) According to the principle of three-dimensional imaging of incoherent chirped signal modulated by continuous wave laser, the differential frequency signal is generated by multiplying the delayed chirp signal and the local oscillator signal. From the perspective of energy utilization, due to the A/D conversion of the differential frequency signal, the energy of the differential frequency signal within the sampling interval of the A/D conversion is not used, and because the energy of the delayed chirp signal is positive with the emission energy of the continuous wave laser, therefore, the average laser emission power of the prior art (incoherent chirped signal AM continuous wave laser 3D imaging) is higher and the ranging range is smaller;

(2) As shown in FIG. 2 and the working principle of the system that the prior art adopts devices such as broadband amplifiers, mixers and A/D etc. The dynamic range of these devices limits the dynamic range of the received laser signal, thus limiting the dynamic reception range of the technology;

(3) The performance of the laser three-dimensional imaging system realized by the prior art is greatly affected by frequency modulation linearity and frequency modulation flatness of the chirp signal.

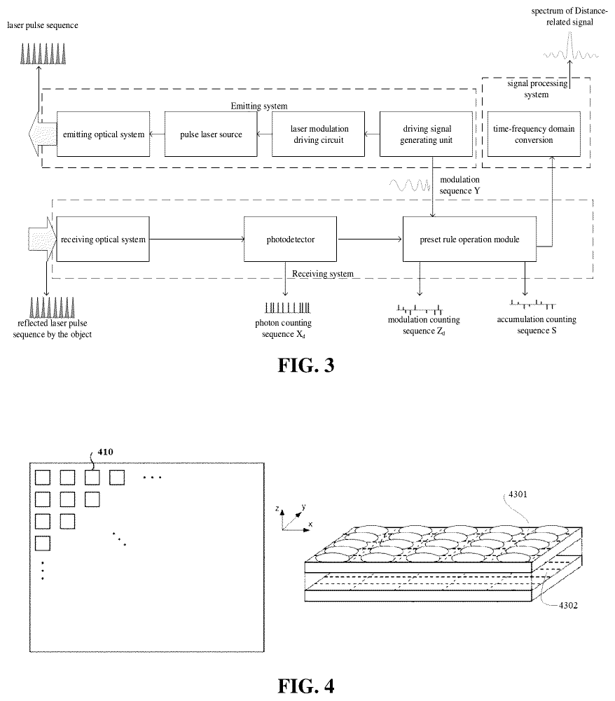

Because of the technical problems existing in the prior art non-coherent detection methods and the huge amount of complex data in data processing, etc., the inventor of the disclosure proposes an improved detection method and detection system. As shown in FIG. 3, the detection system uses a pulsed laser, so the active detection laser emitted is a pulsed laser sequence segment composed of a pulse sequence. The driving signal generating unit in the system generates a drive signal. The drive signal here can be similar to the chirp signal in the above example, also can be other types of driving signals. The essential feature of the driving signal here is to modulate the emitted laser light to obtain an emitted light signal with identifiable characteristics. The driving signal acts on the pulsed laser source through the laser modulation driving circuit, and the laser source can utilize at least part of the characteristics of the driving signal, such as the total period of the driving signal as the period of the pulse sequence segment, and the individual pulses in the pulse segment can be selected to have the same or similar peak value, the peak duration is the same or similar, or the amplitude information of the driving signal is used as the basis for the peak value of the pulse sequence. At this time, the peak values contained in the pulse sequence can be different, and even the law of decreasing or increasing of the small period in the segment of the driving signal can be taken as the basis of the trigger probability of the pulse in the segment of the emitting laser, thus producing the pulse-type laser segment with different spacing configuration and so on. The specific implementation scheme of the pulsed laser segments emitted by the pulsed laser source is not limited here. The emitted pulsed laser sequence is reflected by the detected objects in the field of view to generate a returned light signal, and the returned light signal is received by the photodetector to form a photon counting sequence. At this time, on the one hand the preset rule operation module included in the processing module uses the drive signal to generate a discontinuous modulation sequence Y, On the other hand, the distance related signal can be obtained by calculating the photon counting sequence and the modulation sequence Y according to the preset rules. The distance related signal then passes through a time-frequency domain conversion module to obtain a spectrum signal converted by the distance related signal, and then utilizes the characteristics of the spectrum signal, for example, a peak feature (which contains information about the highest peak, the second highest peak, or the peak in the region of interest, etc.) to output information included the distance of the detected objects as well as included information about the velocity, etc., there are no specific limited here. It is similar to the pulse-type discontinuity detection scheme, a unit that can perform time-frequency domain conversion processing is included in the time-frequency domain conversion module, for example, the unit can perform wavelet operation, segmented FFT, FFT, chirp-Z operation, DFT, etc., Of course, the specific algorithm implementation will not be described in detail here, and it is only exemplified here. Of course, the time-frequency domain conversion module may also include a threshold detection unit and/or an information calculation unit, which is not limited here.

The light receiving module may adopt an array type receiving module as shown in FIG. 4. The array-type receiving module includes a pixel unit 410 composed of diodes. In actual implementation, M*N pixel units can be used to form the active area of the array-type receiving module, and the number of pixel units can be tens of thousands or even hundreds of thousands etc. here is not limited. The array-type receiving module may include a lens portion 4301 and a base portion 4302 of the detection unit. The lens portion 4301 includes a plurality of lens units, and the lens units may be composed of micro-lens units having a predetermined curvature. In order to ensure maximum utilization of the returned light, the lens portion may also include a structure with more than one layer, and the specific implementation scheme is not limited here. In a better case, the base portion 4302 can be set at the position of the focal plane corresponding to the lens portion 4301, so as to ensure that the detection pixel unit can obtain accurate returned light information to the greatest extent. In this case, the lens of the lens part 4301 can construct an optical channel, so that the signal received by the photosensitive part of the detection unit is near the corresponding focal position. The base portion 4302 of the detection unit includes a photosensitive pixel array arranged in an array type. Here, in order to achieve the requirements of discontinuous detection, the diode of the photosensitive pixel unit here can be a single photon avalanche diode array (SPAD) with single photon sensitivity, a Geiger-mode detector unit array APD, or an array-type detector composed of photon-counting-type detection pixel units with a linear amplification factor, etc., which is not limited here. Since the signal directly output in the detector array of the disclosure is a photon counting sequence, the direct output and transmission of digital signals is achieved, and the preset rule operation module takes the driving signal as the female, and obtains the modulation sequence Y, which is also discontinuous sequence signal, or even directly obtain the digitized modulation sequence Y, both are not analog signals similar to those in the prior art, so do not need to go through A/D analog-to-digital conversion and directly perform correlation operation in the preset rule operation module.

Here, the chirp signal generator is still taken as an example for exemplary description. On the one hand, the chirp signal generator generates a chirp signal as the modulation sequence Y, and the modulation sequence here can be the discretization of the continuous signal in the above example, and finally converted into a digital type modulation sequence signal, here the laser emitted period is the period of chirped signal T (that is the total duration within the lasing segment is the periodic characteristic of the chirped signal). On the other hand, the chirp signal generator controls the laser modulation drive circuit to generate the pulse laser drive signal, the pulse laser drive signal controls the pulse laser source to emit the laser pulse sequence, and the emission optical system projects the laser pulse sequence to the object area; The energy of each laser pulse is equal in the laser pulse sequence, and this is just an example. The receiving system includes a receiving optical system, a photodetector, a digital correlator, a digital integral accumulator, etc., wherein the receiving optical system focuses the reflected laser pulse sequence to the photodetector, the photodetector starts to detect when the laser pulse sequence is emitted, and the photon counting result in the emission period of the laser pulse sequence is obtained. In order to ensure that the subsequent calculation amount is small, firstly illuminated the scene in the field of view by the pulse sequence emitted for L times (wherein L is an integer greater than or equal to 1). More optimally, in order to obtain more accurate detection results, L can be selected to be in the order of hundreds of thousands, etc., which is not limited here. Of course, in order to ensure the accuracy of data or the effect of accurate and fast operation, etc., this is not limited to perform statistics on all the detection results of the L times to obtain statistical values. The statistical photon counting sequence X can be generated here for statistical results obtained by using trigger information of return light less than or equal to L times, for example, the following scenario illustrates a statistical photon sequence X generation and construction scenario. Perform L times(L is a positive integer and L [symbol] 1) cumulative detection on the laser pulse sequence reflected back by the object, each cumulative detection includes M (M is a positive integer and M [symbol] 1) detection pulses, the photon count result obtained by the i-th (i is a positive integer and 1 [symbol] i [symbol] M) detection pulse in the d-th (d is a positive integer and 1 [symbol] d [symbol] L) cumulative detection is x_{di}, the basic counting sequence composed of M probe pulse counting results X is:

$$X = \{ {x}_{i} \vert {\sum }_{d = 1}^{L} {x}_{di} , L ∈ N + , d ∈ N + , i = 1 , 2 , … , N \} \qquad ( 9 )$$

First carry out L times of cumulative detection, the basic counting sequence X (X is a result by accumulating L X_{d}_{^{S}}) is obtained after L cumulative probes, then multiply X and Y to get Z (Z is a result by accumulating L Z_{d}_{^{S}}), and then S is obtained by the piecewise accumulation of Z.

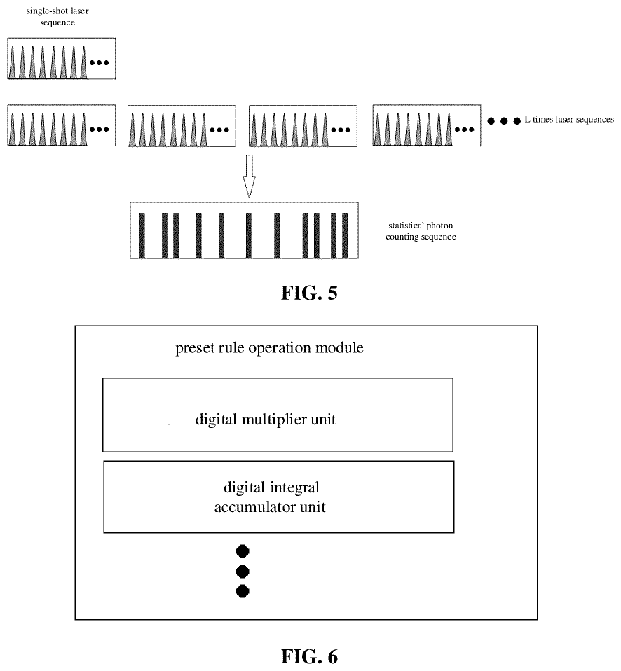

The above steps in principle can be shown as the scheme in FIG. 5, where the laser sequence emitted by a single-shot is the case shown at the top in FIG. 5, the laser sequence emitted each time includes M detection pulses, and the laser source outputs L times pulse laser sequence in the form of L times, and then obtain the trigger information of the returned light of the probe light emitted no more than L times through the detection module to obtain the statistical photon counting sequence, as shown in formula (9), the final constructed statistical photon counting sequence is shown at the bottom of FIG. 5.

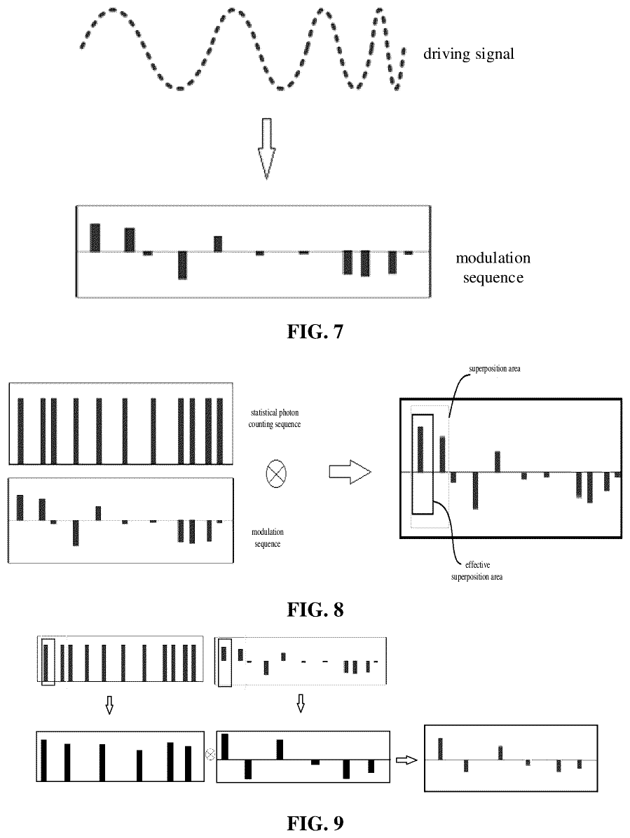

The specific structure of the preset rule operation module is shown in FIG. 6, which includes a digital multiplier unit and a digital integral accumulator unit. Through the digital multiplier unit and digital integral accumulator unit in the preset rule operation module, the self-adaptation to the scene in the detection field of view can be achieved, and the maximum detection distance can be adaptively adjusted with the change of the scene to realize the self-adjustment of detection accuracy, etc., and can also achieve the correlation operation between the signals through the digital multiplier unit to improve the anti-interference ability of the system. That is to say, it can be obtained according to the solution of the following example, the abovementioned statistical photon counting sequence X of the returned light is obtained from L times of pulsed light emission. FIG. 7 is a schematic diagram showing utilizing the drive signal to generate discrete modulation sequence Y. The functional expression of the driving signal is f(x), and a discrete modulation sequence Y similar to the driving emission laser pulse is obtained by using a discretization scheme, wherein the single-shot laser sequence includes M pulsed laser trigger high-value units, and the modulation sequence also includes N pulsed high-value units. The modulation signal is a discontinuous modulation sequence generated by the driving signal generated by the driving signal generating unit according to the similar rule of the emission light pulse sequence, and the result is shown in the following formula (10).

Y={yᵢ|yᵢ=f(i)=1,2, . . . , N} (10)

After obtaining the statistical photon counting sequence and the modulation sequen [symbol] , the preset rule operation module can per [symbol] equences according to the units in the module, so as to obtain the correlation operation results of the two sets of sequences. FIG. 8 and FIG. 9 show two different schemes respectively. According to the operation scheme of FIG. 8, the multiplication operation can be performed on the statistical photon counting sequence and the modulation sequence, that is, the modulation counting sequence Z_{d} can be obtained by using a digital multiplier:

Z_{d}={z_{di}|z_{di}=x_{di}·yᵢ,i=1,2,K,N} (11)

After the calculation of the multiplication unit is completed, the digital integral accumulator can perform segmental accumulation on the modulation count sequence, where the accumulation interval is the interval segment where the accumulation operation is performed, and the processing module can set the actual size of the accumulation interval according to certain rules, performing the segmental accumulation of the multiplication result sequence in the effective superposition area in the interval can obtain the enhancement effect of the signal and at the same time ensure the accuracy of detection. The number of superimposition units in the effective superposition area is K, so the segmental accumulation operation is performed. After that, the segmental cumulative count sequence S_{d} is finally obtained:

$${S}_{d} = \{ {s}_{{d}_{j}} \vert {s}_{{d}_{j}} = {\sum }_{k = 1}^{K} {𝓏}_{d [ ( j - 1 ) \cdot {N}_{0} + k ]} , j = 1 , 2 , K , M \} \qquad ( 12 )$$

Finally, using the digital integral accumulator, the L segmental accumulation counting sequences obtained in L (L is a positive integer and L [symbol] d) laser pulse sequence emission cycles are accumulated, and an accumulation counting sequence S is obtained:

$$S = \{ {s}_{i} \vert {s}_{i} = {\sum }_{d = 1}^{L} {s}_{dj} , j = 1 , 2 , … , M \} \qquad ( 13 )$$

FIG. 9 is another implementation idea. Referring to FIG. 9, we can obtain another implementation scheme of the related operation module. Each unit in this module first performs a segmental accumulation operation for the sequence, that is, the abovementioned statistical photon counting sequence X and modulation sequence Y are firstly divided into the effective superposition interval within the accumulation interval to perform segmental accumulation operation respectively, then perform the multiplication operation on the two sequences, the operation results generated by the two sequences may be different, which is not limited here, but the result information associated with the physical characteristics such as the distance of the detected object and speed of the detected object maybe included in both result, the signal processing system includes time-frequency domain conversion, threshold detection and information calculation, etc. The time-frequency domain conversion realizes the conversion of the spectrum of the accumulative count sequence S according to, for example, wavelet operation, segmental FFT, FFT, chirp-Z operation, DFT, etc., threshold detection realizes the detection of the spectral peak characteristics of the cumulative counting sequence S, including the highest peak information, the second highest peak information or the peak information in the area of interest, etc. The information calculation is based on the spectral information of the cumulative counting sequence S to obtain the target relative information such as distance, relative velocity, and 3D imagery.

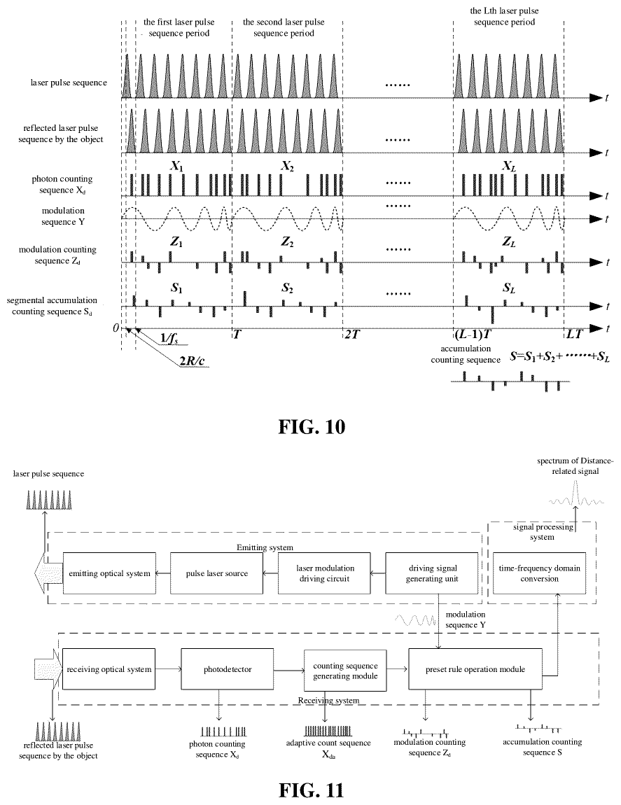

FIG. 10 is a description of another detailed solution for realizing the solution of the disclosure. See FIG. 10 for an illustration. The laser source emits L times of pulse sequence, and the reflected detection laser of the detected object in the field of view forms a photon statistic result X of the returned light at the receiving end, which can be the returned result of L times, performing multiplication operation with each output modulation sequence and each returned photon statistical sequence to obtain the modulated statistical sequence Z, and finally perform the segmental cumulative result to obtain the final counting sequence S, this kind of scheme is also a scheme provided by this disclosure, and the execution step is to use a pulse sequence to obtain X_{d} first.

X_{d}={x_{di}|i=1,2, . . . ,N} (14)

Similar to the previous scheme to obtain a discontinuous modulation sequence Y, then perform multiplication with Xₐ and Y to get Zₐ,

Z_{d}={z_{di}|z_{di}=x_{di}·yᵢ,i=1,2, . . . ,N} (15)

then perform segmental accumulation on Z_{d} to get S_{d}, similar to the segmental accumulation scheme shown in formula (13). Of course, this is only a schematic illustration of a situation, and the actual implementation is not limited to this method. The difference from the above method is that this scheme may require a larger amount of calculation, and a more optimized scheme needs to be used to achieve detection under the requirement of fast output, which is not limited here.

The photon counting sequence or the cumulative photon counting sequence in the above embodiment can not only be generated by the laser pulse sequence received by the photodetector array, but also the ambient background light received by the photodetector array can also generate the photon counting sequence or the cumulative photon counting sequence, the ambient background light includes natural background light and unnatural background light. In addition, when the detector array does not receive photons, it is only caused by the detector array itself. For example, the dark count of the Geiger mode APD photodetector array, the count caused by the noise of the readout circuit, etc., will also generate the photon counting sequence or the cumulative photon counting sequence. wherein, the photon counting results generated by ambient background light and the detector array itself will reduce the signal-to-noise ratio of the detection system, resulting in the deterioration of detection performance.

Since the counting results generated by the natural background light, such as sunlight, and the detector array itself usually obey a certain statistical rule, the above statistical rule can be determined according to the photon counting sequence or the cumulative photon counting sequence; on the other hand, due to the laser pulse sequence generation rules and the photon counting rules generated by the laser pulse sequence are known, so the photon counting statistical rules caused by unnatural background light interference, such as interference light from other detection equipment, can be distinguished from the photon counting sequence or the cumulative photon counting sequence; According to the statistical rule of photon counting generated by the ambient background light and the detector array itself, the photon counting sequence (or cumulative photon counting sequence) generated by the photodetector array can be corrected, thereby improving the signal-to-noise ratio and detection performance of the detection system.

In order to suppress the above problems, in some embodiments, a counting sequence generation module is added in the receiving system, the function of which is to acquire the photon counting sequence, or the statistical characteristics of the cumulative photon counting sequence, and generate an adaptive counting sequence or cumulative self-adaptive counting sequences according to preset rules.

FIG. 11 is a schematic diagram showing a three-dimensional imaging system according to an embodiment of the present disclosure. Compared with FIG. 3, FIG. 11 adds a counting sequence generation module, and the functions of other modules are the same as those shown in FIG. 3, and will not be repeated here. In FIG. 11, the counting sequence generation module generates an adaptive counting sequence according to the statistical characteristics of the photon counting sequence and preset rules.

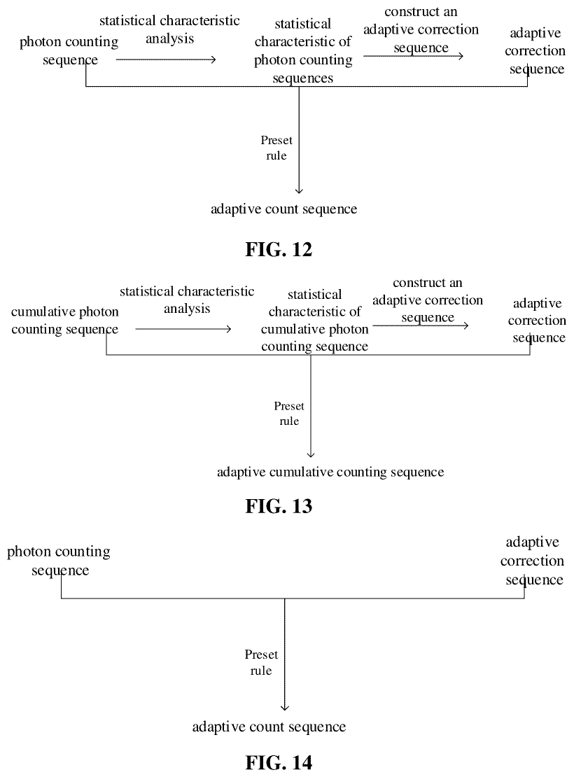

FIG. 12 is a flowchart of generating an adaptive counting sequence according to an embodiment of the present disclosure. In some embodiments, the counting sequence generation module obtains counting results of natural background light, such as sunlight, etc., and counting results generated by the detector array itself according to the photon counting sequence, and generates an adaptive counting sequence according to the counting results. The specific way is that the adaptive counting sequence module according to the photon counting sequence:

X_{d}={x_{di}|i=1,2,K,N} (16)

Summing X_{d} described in formula (16) to obtain:

$${A}_{d} = {\sum }_{i = 1}^{N} {x}_{di} \qquad ( 17 )$$

Or averaging X_{d} described in formula (16) to obtain:

$$\overline{{X}_{d}} = \frac{1}{N} {\sum }_{i = 1}^{N} {x}_{di} \qquad ( 18 )$$

The function of formula (17) and formula (18) is to obtain the characteristics of the photon counting sequence. The summing operation in formula (17) and the average value calculation in formula (18) are only for illustration, and no specific limitation here. According to the characteristics of the photon counting sequence, construct an adaptive correction sequence that conforms to a certain distribution, for example, constructing an adaptive correction sequence X_{dm} with a Poisson distribution with a binomial distribution or a mathematical distribution such as a Gaussian distribution, there is not limited on the specific mathematical distribution. The variance and mean of the adaptive correction sequence Xdₘ have some special relationship with the sum of the photon counting sequence X_{d} or the arithmetic mean A_{d}, such as positive or negative correlation, or some special value, here is not limited. Performing the prescribed preset rules operation with the photon count sequence X_{d} and the adaptive correction sequence X_{dm}={x_{dmi}|i=1, 2, . . . , N}, thereby changing the number of high-valued elements in the photon counting sequence X_{d}, to obtain the adaptive count sequence X_{da}. For example, it can be operated according to the preset rules of formula (19):

$${X}_{da} = \{ {x}_{dai} \vert {x}_{dai} = \{ \begin{matrix}{x}_{di} , {x}_{di} \neq 0 \\ {x}_{dmi} , {x}_{di} = 0\end{matrix} , i = 1 , 2 , … , N \} \qquad ( 19 )$$

[symbol] ng sequence X_{da} is obtained by inserting the adaptive correction sequence X_{dm} into the photon counting sequence X_{d}. The subsequent signal processing process performed thereafter is the same as that in the above embodiment, and will not be repeated here.

FIG. 13 is a flowchart of generating an adaptive cumulative count sequence according to an embodiment of the present disclosure. In FIG. 13, the counting sequence generation module generates an adaptive cumulative counting sequence according to the statistical characteristics and preset rules of the cumulative photon counting sequence.

In some embodiments, the counting sequence generation module obtains the counting results generated by natural background light such as sunlight and by the detector array itself according to the photon counting sequence, and generates an adaptive counting sequence accordingly. The specific way is that the adaptive counting sequence module according to the cumulative photon counting sequence.

$$X = \{ {x}_{i} \vert {\sum }_{d = 1}^{L} {x}_{di} , L ∈ N + , d ∈ N + , i = 1 , 2 , … , N \} \qquad ( 20 )$$

summing the sequence in formula (20) obtains:

$$A = {\sum }_{i = 1}^{N} {x}_{i} \qquad ( 21 )$$

Or averaging the series in formula (20) to obtain:

$$\overline{X} = \frac{1}{N} {\sum }_{i = 1}^{N} {x}_{i} \qquad ( 22 )$$

The function of formula (21) and formula (22) is to obtain the characteristics of the cumulative photon counting sequence. The summing operation in formula (21) and the averaging operation in formula (22) are only for illustration, and are not limited here. According to the characteristics of the cumulative photon counting sequence, construct an adaptive correction sequence that conforms to a certain distribution, such as constructing an adaptive correction sequence Xₘ with a mathematical distribution such as a Poisson distribution with a binomial distribution or a Gaussian distribution, there is no limiting on the specific mathematical distribution. The variance and average of adaptive correction sequence Xₘ and the sum or the arithmetic average of the cumulative photon count sequence X have certain specific relationships, such as positive correlation or negative correlation, or some specific values, which are not specifically limited here. Perform operation on cumulative photon count sequence X and the adaptive correction sequence Xₘ={xₘᵢ |i=1, 2, . . . , N} according to the specified preset rules, thereby changing the number of high-value elements in the cumulative photon counting sequence X, and obtaining the adaptive cumulative counting sequence Xₐ. For example, it can be operated according to the preset rules of formula (23):

Xₐ={xₐᵢ|xₐᵢ=xᵢ+xₘᵢ,i=1,2, . . . ,N} (23)

The preset rule of formula (23) is equivalent to accumulate the adaptive correction sequence Xₘ and the cumulative photon counting sequence X to obtain the adaptive cumulative counting sequence Xₐ.

In some other embodiments, from formula (20) to formula (22) and the variance of the sequence shown in formula (20):

$$σ = \sqrt{\frac{1}{N - 1} {\sum }_{i = 1}^{N} {x}_{i}^{2}} \qquad ( 24 )$$

and other characteristics to get the threshold X_{H}, for example, the threshold can be set as: X_{H}=X̅+λσ wherein λ is a certain positive integer, which is not s limited here. Filter out the high-value elements in the cumulative photon count sequence X which values are greater than the threshold X_{H}. analyzing the distribution characteristics of the above-mentioned high-value elements and combining the known emission frequency characteristics of the laser pulse sequence, distinguishing and eliminating the high-value elements caused by the interference of unnatural background light, and obtain the adaptive cumulative counting sequence Xₐ.

It can be operated according to the preset rules in the following formula (25) to obtain the adaptive cumulative count sequence Xₐ:

$${X}_{a} = \{ {x}_{ai} \vert {x}_{ai} = \{ \begin{matrix}{x}_{i} , {x}_{i} & \begin{matrix}elements that are not caused by \\ unnatural background light\end{matrix} \\ \overline{X} , {x}_{i} & \begin{matrix}elements produced by the interference \\ of unnatural background light\end{matrix}\end{matrix} , i = 1 , 2 , … , N \} \qquad ( 25 )$$

The subsequent processing performed thereafter is the same as that in the above embodiment after the adaptive accumulating count sequence Xₐ is obtained and will not be repeated here.

The real-time generation of the adaptive counting sequence in the above-mentioned embodiment will enhance the anti-interference effect, but at the same time, it also increases the difficulty of implementing the imaging system.

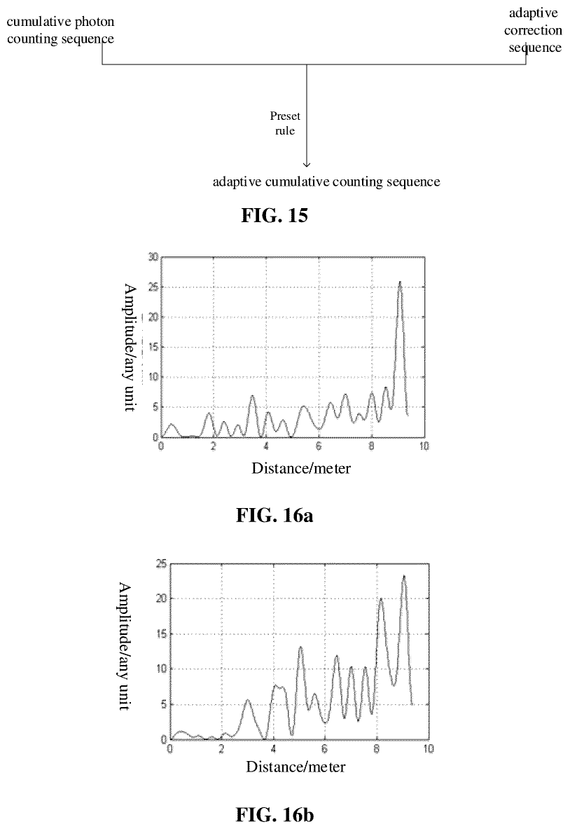

FIG. 14 is another flowchart showing generating an adaptive counting sequence according to an embodiment of the present disclosure. In some other embodiments, the, the counting sequence generating module can also use a prior information of counting statistics generated by natural background light (such as sunlight) interference (such as sunlight), detector array itself reason, unnatural background light (such as interference light of other detection equipment) interference (such as interference light of other detection equipment) and so on, pre-generated the adaptive correction sequence. In this implementation manner, the pre-generated adaptive correction sequence is stored in the counting sequence generation module, and the adaptive correction sequence is not generated in real time and dynamically according to the photon counting sequence or the cumulative photon counting sequence. The flowchart of generating the adaptive counting sequence is shown in FIG. 14, and the flowchart of generating the adaptive cumulative count sequence is shown in FIG. 15. The preset rules described in FIG. 14 and FIG. 15 may be the same as the preset rules in the above-mentioned embodiment, and are not described here. The subsequent signal processing process is the same as that in the above embodiment, and will not be repeated here.

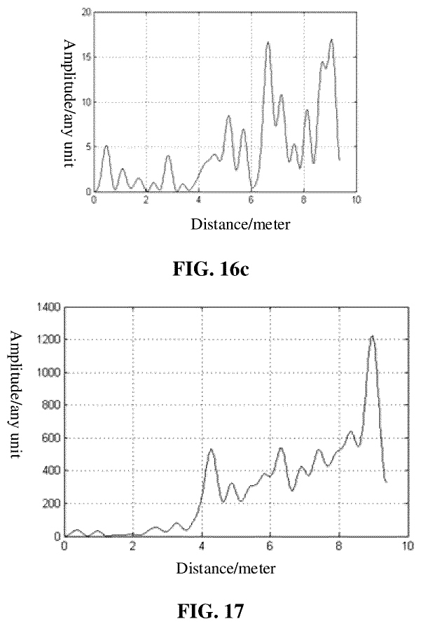

FIG. 16a to FIG. 16c are schematic diagrams showing the spectrum of the distance-related signal without the adaptive counting sequence or the adaptive cumulative counting sequence according to the embodiment of the present application, which is the spectrum of distance-related when the natural background light of a certain intensity (such as sunlight, etc.) and the detector array itself are counted without adding the adaptive counting sequence or the adaptive cumulative counting sequence. At this time, there is a greater probability to obtain the distance-related signal spectrum shown in FIG. 16(a), which has a high signal-to-noise ratio, and the maximum value of its spectrum amplitude reflects the object distance; there is a greater probability to obtain the distance-related signal spectrum shown FIG. 16(b) and the signal-to-noise ratio of the distance-related signal spectrum is lower than that shown in FIG. 16(a). Although the maximum value of the spectrum amplitude can still reflect the object distance, because the second maximum value of the spectrum amplitude is closer to the maximum value of the spectrum amplitude, the average noise power of the spectrum is higher, thus increasing the difficulty of extracting the object distance; there is a small probability to obtain the distance-related signal spectrum shown in FIG. 16(c), the signal-to-noise ratio of which is further reduced, and the second maximum value of the spectrum amplitude is more closer to the maximum value of the spectrum amplitude, and the difficulty of extracting the target distance is further increased.

FIG. 17 is a schematic diagram showing the spectrum of the distance-related signal with the adaptive counting sequence or the adaptive cumulative counting sequence according to the embodiment of the present application. At this time, the distribution of high-value elements in the adaptive counting sequence or the adaptive cumulative counting sequence is more uniform, so that the distance-related signal spectrum shown in FIG. 17 can be obtained which has a high signal-to-noise ratio and the maximum amplitude of the spectrum reflects the target distance.

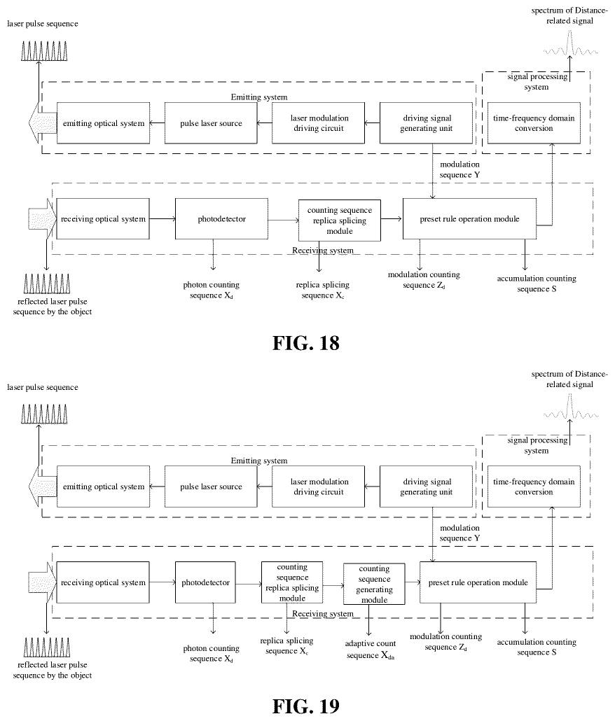

FIG. 18 is a schematic diagram showing a detection system according to the embodiment of the present application. As shown in FIG. 18, which differs from the embodiment shown in FIG. 3 is that a counting sequence replica splicing module is added between the photodetector and the digital multiplier in the detection system, the other modules are identical to the embodiment shown in FIG. 3, and will not be repeated here.

FIG. 19 is another schematic diagram showing detection system according to the embodiment of the present application. As shown in FIG. 19, which differs from the embodiment shown in FIG. 11 is that a counting sequence replica splicing module is added between the photodetector and the counting sequence generation module in the detection system, and the other modules are the same as the embodiment shown in FIG. 11, and will not be repeated here.

In the embodiments shown in FIG. 18 and FIG. 19, the counting sequence replica splicing module converts the photon counting sequence X_{d} to a replica splicing Sequence X_{c}:

X_{c}={x_{ci}|i=1,2, . . . ,N} (26)

The digital multiplier obtains the modulation count sequence Z_{d}:

Z_{d}={z_{di}|z_{di}=x_{ci}·yᵢ, i=1,2, . . . ,N} (27)

The preset rule operation module segmental accumulates the modulation count sequence Z_{d} to obtain segmental cumulative count sequence S_{d}:

$${S}_{d} = \{ {s}_{dj} \vert {s}_{dj} = {\sum }_{k = 1}^{K} {z}_{d [ \{ j - 1 \} {N}_{0} + k ]} , j = 1 , 2 , … , M \} \qquad ( 28 )$$

In the formula, N₀ is the integer closest to N/M, K is an integer and

$$\frac{2 {R}_{max}}{c Δ t} \leq K \leq {N}_{0}$$

(Rₘₐₓ is the maximum detectable distance).

The preset rule operation module accumulates the L segment accumulative counting sequences obtained in the process of emitting the L laser pulse sequences, and obtains the accumulative counting sequence S:

$$S = \{ {s}_{j} \vert {s}_{j} = {\sum }_{d = 1}^{L} {s}_{dj} , L ∈ N + , j = 1 , 2 , … , M \} \qquad ( 29 )$$

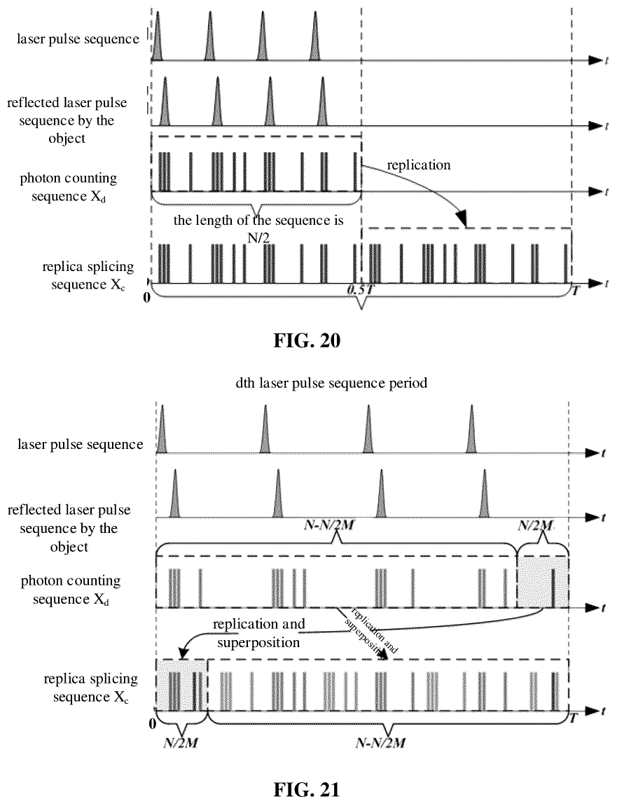

In the embodiment shown in FIG. 18 and FIG. 19, the counting sequence replica splicing module obtains the replica splicing sequence X_{c} by replicating one or more elements of the photon counting sequence X_{d} and splicing them with the photon counting sequence X_{d}. FIG. 20 is a schematic diagram showing a replica splicing sequence according to the embodiment of the present disclosure. In the embodiment shown in FIG. 20, the emission period of the laser pulse sequence is equal to the chirp signal period T, but each laser pulse sequence consists of

[symbol]

$${M}_{0} = \frac{M}{2} = \frac{{f}_{n} \cdot T}{2}$$

(M is a positive integer) laser pulses (in FIG. 7, each laser pulse sequence consists of M₀=M/2=4 laser pulses), that is, the laser pulse is only emitted in the first half period of the chirped signal, so in the first half period of the chirped signal, the photon count sequence X_{d} is obtained when the detector detects the dth(d is positive integer and d [symbol] L) laser pulse sequence, and the number of elements is N₀=N/2:

$${X}_{d} = \{ {x}_{di} \vert i = 1 , 2 , … , {N}_{0} , {N}_{0} = \frac{N}{2} \} \qquad ( 30 )$$

At this time, all the elements in the photon counting sequence X_{d} are treated as the first N/2 term in the replica splicing sequence X_{c}, and all the elements in the photon counting sequence X_{d} are replicated as the last N/2 terms in the replica splicing sequence X_{c}, thus the replica splicing sequence X_{c} represented by formula (26) is obtained, whose element number is N. The embodiment shown in FIG. 20 is for illustrative only, and is not limited to only emitting laser pulses in half a period, and can emit laser pulses in ⅓ period, ¼ period . . . , the replicated splicing signal is obtained by the method of the embodiment shown in FIG. 20.

FIG. 21 is another schematic diagram showing a replica splicing sequence according to the embodiment of the present disclosure. In the embodiment shown in FIG. 18 and FIG. 19, the counting sequence replica splicing module can obtain the replica splicing sequence through the embodiment shown in FIG. 21. In the embodiment shown in FIG. 21, the emission period of the laser pulse sequence is equal to the chirp signal period T, and each laser pulse sequence consists of M=fₛ·T (M is a positive integer) laser pulses (in FIG. 21 each laser pulse sequence is composed of M=4 laser pulses), the photon count sequence obtained during the photodetector detects the dth (d is a positive integer and d [symbol] 21 L) laser pulses is X_{d}, the elements number of the photon count sequence is N. All elements in the photon counting sequence X_{d} are replicted, and the first N−N/2M (assuming that N can be divisible by 2M=8, N=64 shown in FIG. 21) elements are accumulated with the last N−N/2m elements in X_{d}; Accumulating the last N/2m elements and the first N/2m elements in X_{d} to obtain the X_{c}, the number of elements is also N, that is:

$${X}_{c} ( i ) = \{ \begin{matrix}{X}_{d} ( i ) + {X}_{d} ( N - \frac{N}{2 M} + i ) , i \leq \frac{N}{2 M} \\ {X}_{d} ( i ) + {X}_{d} ( i - \frac{N}{2 M} ) , \frac{N}{2 M} + 1 \leq i \leq N\end{matrix} \qquad ( 31 )$$

As a comparison, according to the method in the embodiment shown in FIG. 3 and the embodiment shown in FIG. 11, an accumulated count sequence S including M elements can be obtained through a laser pulse sequence including M pulses. In the method of the embodiment shown in FIG. 18 and shown in FIG. 19, the cumulative count sequence S obtained by a laser pulse sequence including M pulses, the elements number of the cumulative count sequence maybe more than M. Since the object information is obtained by analyzing the spectral characteristics of the cumulative count sequence S, if the object information obtained from the cumulative count sequence S obtained by the methods in the embodiments shown in FIG. 3 and FIG. 18 iₛ basically same as the object information from the cumulative count sequence S obtained by the method in embodiments shown in FIG. 18 and FIG. 19, then using the methods in the embodiments shown in FIG. 18 and FIG. 19, the total required laser emission energy will be smaller, the detection efficiency will be higher.

The method in the embodiment shown in FIG. 21 can be repeatedly executed. Based on the last execution result, some elements in the last result are accumulated and spliced again to obtain a new sequence, which can further improve the ranging accuracy. The embodiment shown in 21 is only for schematic illustration, and not limited here.

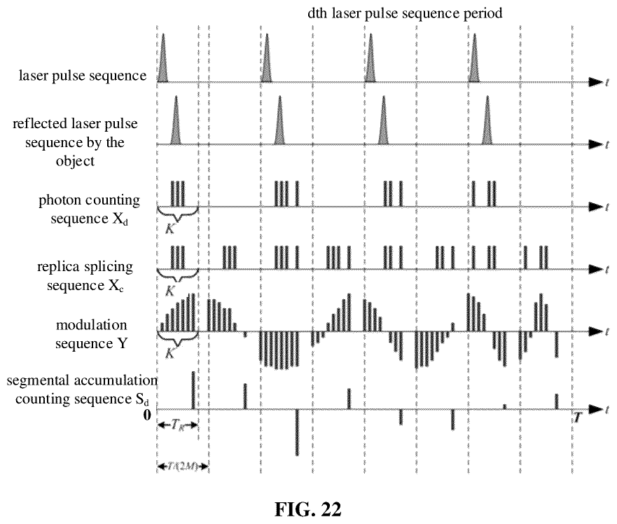

FIG. 22 is a schematic diagram showing waveforms during three-dimensional imaging according to the embodiment of the present disclosure, which is a schematic diagram of waveforms during three-dimensional imaging in the embodiment shown in FIG. 18. The principle of the three-dimensional imaging schematic diagram of the embodiment shown in FIG. 19 is similar to that in FIG. 18, and details are not repeated here. In the embodiment shown in FIG. 18, the driving signal generating unit generates two signals, one of which controls the laser modulation driving circuit, and then controls the pulsed laser to emit laser light, after beam shaping and expanding by the emitting optical system, the laser pulse sequence is projected to the object area. The laser pulse sequence reflected by the object is filtered and shaped by the receiving optical system, and then focused on the photodetector. FIG. 22 shows a schematic diagram of some waveforms corresponding to a possible implementation. Wherein the emission period of the laser pulse sequence is T, and each period includes M=4 pulses. In the d-th laser pulse sequence emission period, the photodetector detects firstly in T_{R} time after the laser pulse sequence begins to emit the first pulse, that is, in the time interval 0 [symbol] t [symbol] T_{R} the first detection is performed, and the photon count sequence X_{d1} of the first detection is obtained, the number of elements is K, if the maximum detectable distance of laser 3D imaging is Rₘₐₓ, then T_{R} [symbol] 2Rₘₐₓ/c (c is the speed of light in vacuum), in the first detection, the number of elements of the modulation sequence Y₁ of the first detection is also K, the modulation count sequence Z_{d1} in the first detection can be obtained by multiplying the corresponding elements in X_{d1} and Y₁, summing the elements in Z_{d1} can get S_{d1}, take S_{d1} as the first element of the segmental accumulative count sequence S in the emission period of a certain laser pulse sequence.

In the time period T/M [symbol] t [symbol] T/M+T_{R} the second detection is performed. Although there is no pulse emission during the second detection, the photodetector can still detect the photon counting sequence X_{d2} of the second detection, whose number of elements is K, in the second detection, the number of elements of the modulation sequence Y₂ is also K, accumulating the corresponding elements in X_{d1} and X_{d2} to get X_{d2′}, multiplying the corresponding elements in X_{d2′} and Y₂ to obtain the modulation count sequence Z_{d2} in the second detection, it is also possible to make X_{d2}=X_{d1}, multiplying the corresponding elements in X_{d2} and Y₂ to obtain the modulation count sequence Z_{d2} in the second detection, accumulating the elements in Z_{d2} to obtain S_{d2}, take S_{d2} as the second element of segmental accumulative count sequence S_{d} in the emission period of a certain laser pulse sequence.

Similar, in the third, fifth, and seventh detections, the steps of the first detection are correspondingly executed; in the fourth, sixth, and eighth detections, the corresponding executions are performed according to the steps of the second detection, which will not be repeated here, the remaining elements of S_{d} are obtained respectively, the segmental cumulative count sequence S_{d} obtained at the dth laser pulse sequence cycle as shown in the bottom row of FIG. 22. Finally, accumulating the corresponding units of S1, S2, . . . , SL obtained by L laser pulse sequence cycles in total of L subsection accumulative counting sequences to obtain the accumulative counting sequence S, the detect information can be obtained by analyzing the spectral characteristics of the accumulative counting sequence S, and then realize 3D imaging.

On the whole, in addition to the above-mentioned incoherent chirped signal AM continuous wave laser 3D imaging technology (hereinafter referred to as technology 1), the existing technology mainly includes incoherent sinusoidal/pulse AM laser 3D imaging technology (itof, hereinafter referred to as technology 2), and pulsed photon counting laser three-dimensional imaging technology (dtof, hereinafter referred to as technology 3), compared with the above-mentioned technology, the present disclosure has the following advantages:
1) Compared with technology 1, the present disclosure uses pulsed laser for detection, which avoids the problem of wasting laser emission energy within the sampling interval of A/D conversion in technology 1, thus greatly improving the energy utilization rate and reducing the average laser emission power;
(2) Compared with technology 1, the application does not use devices such as broadband amplifiers, mixers, and A/Ds in the receiving system, which avoids the problem that the above-mentioned devices limit the dynamic range of the received laser signal, thereby making the receiving system of the present disclosure more efficient. The system has a larger dynamic receiving range;
(3) Compared with technology 1, in the receiving system of the present disclosure, a digitized chirp signal is used as a modulation sequence, and a digital multiplier is used to realize sequence multiplication, which reduces the chirp signal FM linearity and FM flatness on ranging performance impact;
(4) Compared with technology 2, the present disclosure has range resolution because the chirped signal is used for correlation reception, which can effectively avoid the influence of multipath effects;
(5) Compared with technology 2, the present disclosure improves the anti-light interference ability due to the use of correlation reception, Fourier analysis and spectrum detection, so the ranging performance is less affected by light interference, and the required laser energy under the same detection situation is smaller;
(6) Compared with technology 2, the present disclosure no longer uses A/D, and has a larger dynamic receiving range;
(7) Compared with technology 3, which the disclosure needs to transmit and process is the cumulative counting sequence, not the photon counting sequence, thus greatly reducing the amount of data transmission;
(8) Compared with technology 3, the present disclosure extracts object distance information from the frequency spectrum, thereby reducing the influence of pulse shape distortion on the ranging performance;
(9) Compared with technology 3, the present disclosure improves the anti-light interference capability by adopting correlation reception, Fourier analysis, and spectrum detection, so the ranging performance is less affected by light interference.

In this disclosure, multiple direct receptions are used to form a distance-amplitude spectrum (frequency domain), and the time-of-flight is determined by threshold detection in the frequency domain and the spectrum peak value. In the specific implementation, the spectrum amplitude threshold value can be set adaptively; the spectrum peak value can also be accurately determined, the scheme as a whole is a digital frame structure type, and more FFT points can be used to ensure the accuracy; the accuracy of detection can be guaranteed under a large amount of calculation, and the exposure time is in the form of accumulated charges introduced, through FFT and correlation reception (zero-average FMCW correlation signal), the problem of background light interference is suppressed from the algorithm level, and the emitting power is completely received in terms of energy utilization, realizing the most efficient energy utilization. The whole system and method solve the problem exist in some schemes, which have broad application prospects and promotion value.

It should be noted that the terms “including”, “comprising” or any other variation thereof are intended to encompass a non-exclusive inclusion such that a process, method, article or device comprising a series of elements includes not only those elements, but also no other elements expressly listed, or which are also inherent to such a process, method, article or apparatus. Without further limitation, an element qualified by the phrase “comprising a . . . ” does not preclude the presence of additional identical elements in a process, method, article or apparatus that includes the element.

The above descriptions are only preferred embodiments of the present disclosure, and are not intended to limit the present application. For those skilled in the art, the present disclosure may have various modifications and changes. Any modification, equivalent replacement, improvement, etc. made within the spirit and principle of this application shall be included within the protection scope of this application. It should be noted that like numerals and letters refer to like items in the following figures, so once an item is defined in one figure, it does not require further definition and explanation in subsequent figures. The above descriptions are only preferred embodiments of the present disclosure, and are not intended to limit the present application. For those skilled in the art, the present application may have various modifications and changes. Any modification, equivalent replacement, improvement, etc. made within the spirit and principle of this application shall be included within the protection scope of this application.

1. A LIDAR ranging method, includes:
a driving signal is generated by the driving signal generating unit and the driving signal acts on a laser source through a laser modulation driving circuit, and the laser source receives the driving signal to emit a pulsed laser sequence;
an array-type returned light receiving module receives the returned light signal reflected by a detected object in the field of view and generates the returned signal; and
a modulation signal is generated by a processing module according to the driving signal generated by the driving signal generating unit, and a distance-related signal is obtained by the processing module based on the modulation signal according to a preset rule, and the processing module outputs the distance information of the detected object according to the distance-related signal.

2. The LIDAR ranging method according to claim 1, wherein the returned signal is a photon counting sequence triggered by the returned pulsed laser sequence.

3. The LIDAR ranging method according to claim 2, wherein the driving signal drives the laser source L times to emit a laser sequence of L times, and the array-type returned light receiving module receives the returned signal of the L times laser sequences, the processing module generates a statistical photon counting sequence according to the statistical results of all or part of the returned optical signals of the L times laser sequences, where L is an integer greater than or equal to 1.

4. The LIDAR ranging method according to claim 3, wherein the processing module generates a statistical photon counting sequence according to the statistical results of the returned light signals of all the L times laser sequences.

5. The LIDAR ranging method according to claim 3, wherein the modulation signal is a discontinuous modulation sequence generated by the driving signal generated by the driving signal generating unit according to a rule similar to the emitting light pulse sequence.

6. The LIDAR ranging method according to claim 4, wherein a laser includes M pulsed laser triggering high-value units, or the number of the counting units of the photon counting sequence triggered by the pulse sequence in the receiving module is M, where M is an integer greater than or equal to 1.

7-11. (canceled)

12. The LIDAR ranging method according to claim 1, further includes:
before the processing module obtains the distance-related signal based on the modulated signal according to the preset rule, a counting sequence generating module generates an adaptive counting sequence according to the returned signal,
wherein, the distance-related signal obtained by the processing module based on the modulated signal according to the preset rule includes: the distance-related signal obtained by the processing module based on the modulated signal and the adaptive counting sequence according to the preset rule.

13. The LIDAR ranging method according to claim 12, wherein the adaptive counting sequence is generated from the returned signal include:
an adaptive correction sequence is generated according to an average value of the returned signals or the sum of the returned signals, and the adaptive count sequence is generated based on the returned signal and the adaptive correction sequence.

14-16. (canceled)

17. The LIDAR ranging method according to claim 1, further includes:
before the processing module obtains the distance-related signal based on the modulation signal according to the preset rule, a counting sequence splicing module obtains a replica splicing signal according to the returned signal;
the distance-related signal obtained by the processing module based on the modulated signal according to the preset rule includes: the distance-related signal obtained by the processing module based on the modulated signal and the replica splicing signal according to the preset rule.

18-19. (canceled)

20. The LIDAR ranging method according to claim 17, wherein based on the latest replica splicing signal, the counting sequence splicing module replicates some elements of the latest replica splicing signal, and operates with the latest replica splicing signal to obtain the replica splicing signal.

21. A detection system for distance detection, includes:
a driving signal generating unit configured to generate a driving signal and act on a laser source through a laser modulation driving circuit, wherein the laser source receives the driving signal to emit a pulsed laser sequence;
an array-type returned light receiving module configured to receive the returned light signal reflected by a detected object in the field of view, and generates the returned signal;
and
a processing module configured to generate a modulation signal according to the driving signal generated by the driving signal generator, obtain a distance-related signal based on the modulation signal according to a preset rule, and outputs the distance information of the detected object according to the distance-related signal.

22. The detection system according to claim 21, wherein the returned signal is a photon counting sequence triggered by the returned pulsed laser sequence.

23. The detection system according to claim 22, wherein the driving signal drives the laser source L times to emit a laser sequence of L times, and the array-type returned light receiving module receives the returned light signal of the L times laser sequence, the processing module generates a statistical photon counting sequence according to the statistical results of all or part of the returned optical signals of the L times laser sequence, where L is an integer greater than or equal to 1.

24. The detection system according to claim 23, wherein the processing module generates a statistical photon counting sequence according to a statistical result of the returned light signals of all the L times laser sequences.

25. The detection system according to claim 23, wherein the modulation signal is a discontinuous modulation sequence generated by the driving signal generated by the driving signal generating unit according to a rule similar to the emitting light pulse sequence.

26. The detection system according to claim 24, wherein a single-shot laser sequence includes M pulsed laser triggering high-value units, or the number of counting units of the photon counting sequence triggered by the pulse sequence in the receiving module is M, where M is an integer greater than or equal to 1.

27.-31. (canceled)

32. The detection system according to claim 21, further includes:
a counting sequence generation module configured to generate an adaptive counting sequence according to the returned signal,
wherein, the processing module is further configured to obtain the distance-related signal based on the modulation signal and the adaptive counting sequence according to the preset rule.

33. The detection system according to claim 32, the counting sequence generation module is configured to: generate an adaptive correction sequence according to an average value of the returned signal or the sum of the returned signal, and based on the returned signal and the adaptive correction sequence to generate the adaptive count sequence.

34.-36. (canceled)

37. The detection system according to claim 21, further includes:
a counting sequence splicing module configured to obtain a replica splicing signal according to the returned signal;
the processing module is further configured to obtain the distance-related signal based on the modulated signal and the replica splicing signal according to the preset rule.

38.-39. (canceled)

40. The detection system according to claim 37, wherein based on the latest replica splicing signal, the counting sequence splicing module replicates some elements of the latest replica splicing signal, and operates with the latest replica splicing signal to obtain the replica splicing signal.
